(19) United States
(12) Patent Application Publication
(10) Pub. No.: US 2024/0238928 A1
(43) Pub. Date: Jul. 18, 2024

(54) GRINDING WHEELS CHANGING STRUCTURE

(71) Applicant: AGILE WING SMART MANUFACTURING CO., LTD, Taichung City (TW)

(72) Inventors: Yong Lin CHEN, Taichung City (TW); Hung Wu LEE, Taichung City (TW)

(21) Appl. No.: 18/410,261

(22) Filed: Jan. 11, 2024

(30) Foreign Application Priority Data
Jan. 18, 2023 (TW) 112102248

(51) Int. Cl. B23Q 3/157

(52) U.S. Cl. CPC B23Q 3/1572

(57) ABSTRACT

A grinding wheel changing structure of grinding machines includes a base to which a clamping device, a grinding device, a storage device, a gripping device are mounted thereon. The clamping device clamps workpieces. The grinding device is movable along two axes and includes a grinding wheel and a guard. The grinding wheel is located inside the guard. A lid is pivotably connected to the guard. The storage device has multiple grinding wheels detachably stored therein. The gripping device is located between the grinding device and the storage device. The gripping device is linearly movable and includes a gripping unit which is rotatable. By using the gripping device with its gripping unit to grasp the grinding wheel and shuttle back and forth, rotate between the grinding device and the storage device, to load and unload the grinding wheel.

### FIELD OF THE INVENTION

The present invention relates to a field of machining machinery, particularly to a grinding wheel changing structure of grinding machines.

### BACKGROUND OF THE INVENTION

Grinding machines are machine tools that are used to process workpieces using grinding wheels to remove excess material from workpieces to achieve the desired dimensions and surface finishes. Grinding involves processes such as flat grinding, angular grinding, vertical grinding, surface grinding, and profile grinding. The precision manufacturing of most mechanical components relies on grinding work, making grinding an essential part of precision machining.

When using grinding machines, there are grinding wheels designed for shaping the outer contour of the workpieces. By matching the shape of the grinding wheel to the desired contour, it becomes possible to efficiently process the entire surface of the workpiece directly, leading to faster completion of the machining process. To maintain precision, grinding machines often use automatic wheel-changing devices. These devices facilitate the replacement of grinding wheels by controlling the replacement at the same position on the spindle. This helps reduce the adjustment time for correcting positions, as disclosed in Chinese Patent Publication No. CN110394735A, titled “Device for Automatically Changing Grinding Wheel.”

However, the aforementioned automatic grinding wheel-changing device requires the integration of a four-axis robotic arm and machine vision positioning software, resulting in a high overall equipment cost. Additionally, the grinding wheel storage of this device is located relatively far from the grinding device, leading to longer travel paths for the robotic arm to replace the grinding wheel. This results in a longer replacement time, highlighting the need for improvement in this aspect.

The present invention intends to provide a grinding wheel changing structure of grinding machines to improve the shortcomings mentioned above.

### SUMMARY OF THE INVENTION

The present invention relates to a grinding wheel changing structure of grinding machines and comprises a base to which a clamping device, a grinding device, a storage device and a gripping device are connected thereto. The clamping device clamps workpieces of different lengths, and the clamping device is adjustable along an x-axis. The grinding device is movable along the x-axis and a y-axis relative to the clamping device. The grinding device includes a grinding wheel and a guard. The grinding wheel is located inside the guard. A lid is pivotably connected to the guard and actuated by a first cylinder. The storage device is connected to the base in z-axis and has multiple grinding wheels detachably stored therein which are rotatable about the x-axis. The gripping device is positioned between the grinding device and the storage device. The gripping device is linearly movable along the x-axis relative to the base. The gripping device includes a gripping unit which is rotatable in the z-axis. A controller controls the gripping device through the gripping unit to grip the grinding wheel. The gripping device moves back and forth, and rotates between the grinding device and the storage device so as to provide automatic loading and unloading for the grinding wheel.

Preferably, the controller is electrically connected to the clamping device, the grinding device, the storage device, and the gripping device. The controller includes an automatic unloading program and an automatic loading program stored therein.

Preferably, the automatic unloading program is proceeded as follows:

moving the grinding device away from the storage device to a preset distance;

opening the lid of the guard;

moving the gripping device to approach the guard;

using the gripping unit to grasp and unload the grinding wheel to be unloaded in the guard;

moving the gripping device away from the guard and using the gripping unit to rotate the grinding wheel to be unloaded on the griping device;

withdrawing the gripping device and approaching the gripping device toward the storage device;

inserting the grinding wheel to be unloaded into the storage device, and

moving the gripping device to return to an initial position to complete the automatic unloading program.

Preferably, the automatic loading program is proceeded as follows:

positioning one of the grinding wheels to be loaded stored in the storage device to a predetermined location;

moving the grinding device away from the storage device to a preset distance;

opening the lid of the guard;

withdrawing the gripping device to approach the storage device;

using the gripping unit to grasp the grinding wheel to be loaded from the storage device;

moving the gripping device and using the gripping unit to rotate the grinding wheel to be loaded;

moving the gripping device to approach the guard;

inserting the grinding wheel to be loaded into the guard;

withdrawing the gripping device to an initial position, and

closing the lid of the guard to complete the automatic loading program.

Preferably, the lid of the guard is opened by lifting the lid upward, the lid is pivotably connected to a top of the guard and actuated by the first cylinder.

Preferably, the gripping device is actuated by a second cylinder, the gripping unit is rotated by a rotating cylinder, a stepper motor, or a servo motor.

Preferably, each grinding wheel includes a spindle, and the spindle includes a locking groove located relative to the gripping unit.

Preferably, the storage device is connected to one side of the base and includes a frame, a turntable, and a driving unit. The turntable is hinged to a top of the frame and carries the grinding wheels. The driving unit is located between the frame and the turntable, and electrically connected to the controller. The driving unit drives the turntable.

Preferably, the gripping unit is rotated 180 degrees.

The present invention includes the following advantages:

The present invention can replace the expensive equipment in existing grinding machines for the automatic replacement of grinding wheels at a low cost. For example, it eliminates the need for costly components such as robotic arms and machine vision positioning software. The storage device of the present invention can open the lid of the guard of the grinding device, and the gripping device that transports grinding wheels between the storage device and the guard of the grinding device. This achieves the functions of high-cost equipment by using cost-effective technical means.

The location of the storage device of the present invention is closer to the grinding device, resulting in shorter travel paths for the gripping device. This allows for faster replacement of grinding wheels, enhancing the efficiency of grinding operations.

The storage device built in the structure of the present invention can accommodate a greater variety of grinding wheels, meeting the requirements for various grinding operations on complex-shaped workpieces.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the grinding machine of the present invention;

FIG. 2 is another perspective view of the grinding machine of the present invention;

FIG. 3 is yet another perspective view of the grinding machine of the present invention;

FIG. 4 is the grinding wheel changing structure of the grinding machine of the present invention;

FIG. 5 is another perspective view of the grinding wheel changing structure of the grinding machine of the present invention;

FIG. 6 shows the flow chart of the controller of the present invention;

FIG. 7 is a side view of the grinding wheel changing structure of the grinding machine of the present invention;

FIG. 8 shows the grinding wheel changing structure of the grinding machine of the present invention is to be operated;

FIG. 9 shows the unloading action of the grinding wheel of the grinding wheel changing structure of the grinding machine of the present invention;

FIG. 10 is a top view of the grinding wheel changing structure of the grinding machine of the present invention;

FIG. 11 shows that the rotational actions of the gripping device rotating 180 degrees, and

FIG. 12 shows that the gripping device rotates 180 degrees and approaches the storage device.

### DETAILED DESCRIPTION OF THE PREFERRED EMBODIMENT

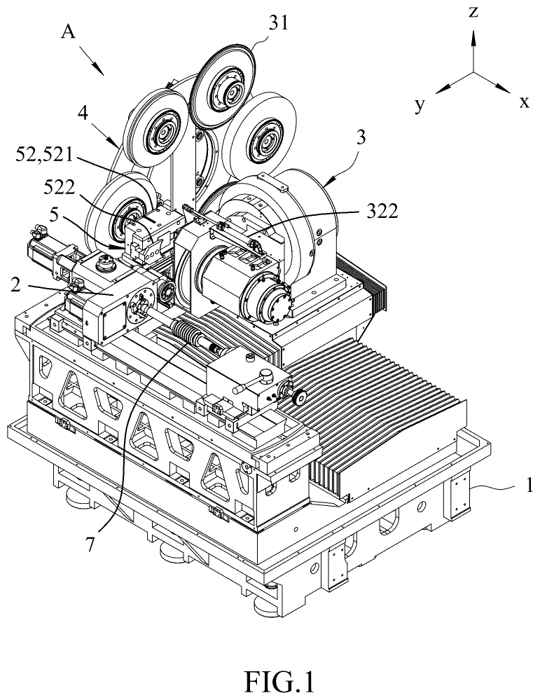

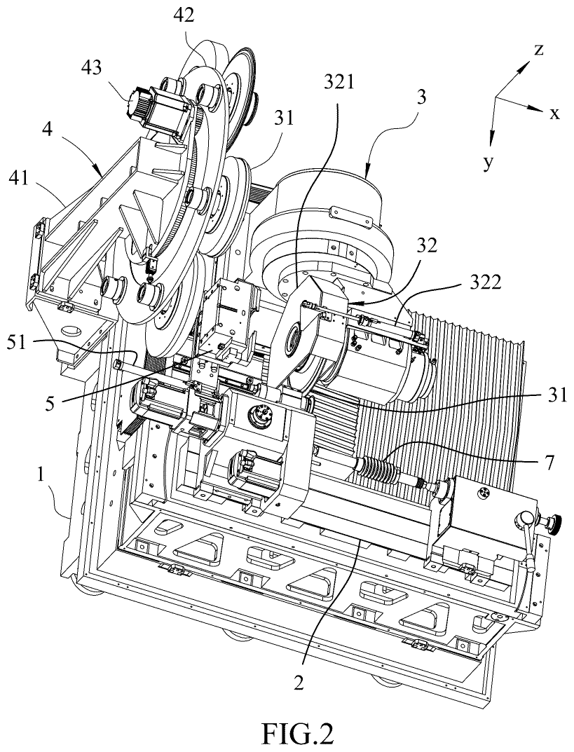

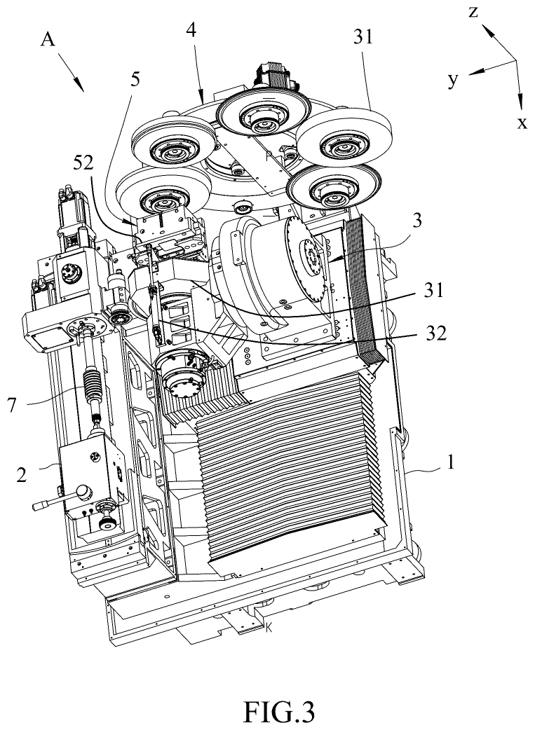

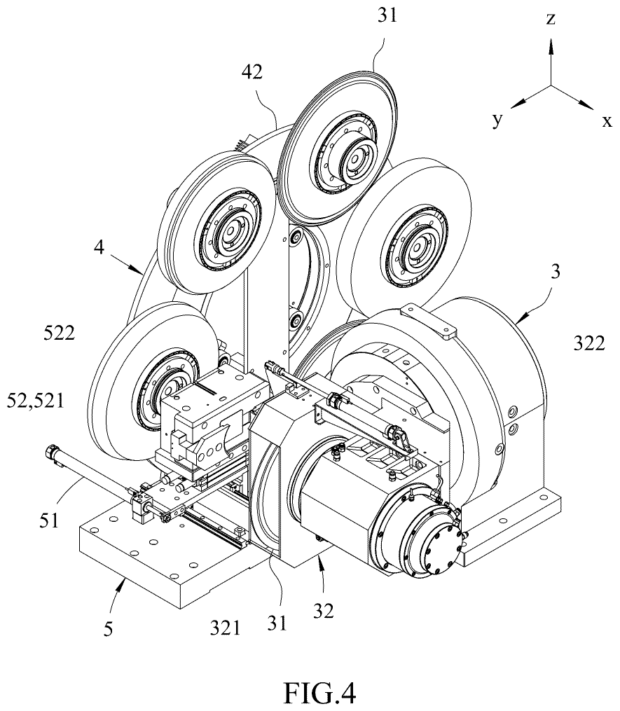

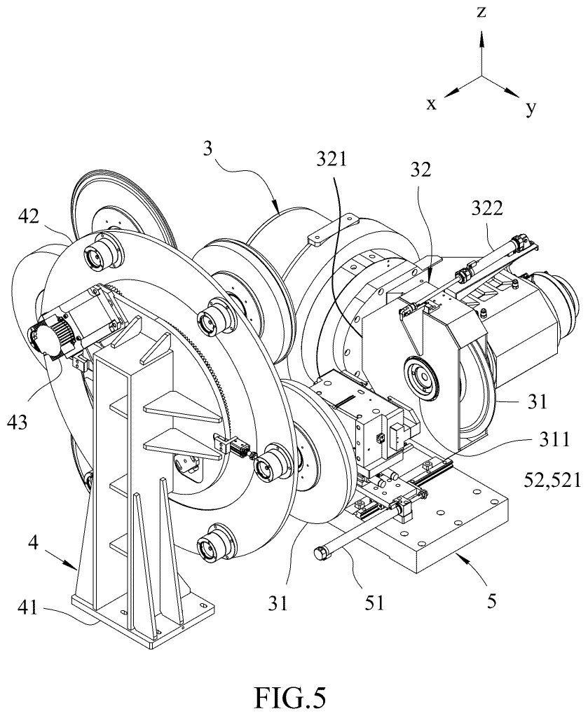

Referring to FIGS. 1-5, the grinding wheel changing structure “A” of grinding machines comprises a base 1 to which a clamping device 2, a grinding device 3, a storage device 4 and a gripping device 5 and or a controller 6 are connected thereto.

The base 1 includes multiple sets of drive screws, combined with linear slide rails, optical scales, servo motors, etc., all controlled by the controller 6. This enables precise displacement of the grinding device 3 along the x-axis and y-axis. Additionally, the gripping device 5 can perform x-axis displacement.

The clamping device 2 is mounted on the base 1 so as to clamp workpieces 7 of different lengths. The clamping device 2 is adjustable along the x-axis and drives the workpiece 7 to rotate, such that the workpiece 7 is ground by the grinding device 3 during rotation. The workpiece 7 can be a cylindrical rod, a threaded rod or other cylindrical part.

The grinding device 3 is mounted on the linear slide rails of the base 1 and is driven by the drive screws so that it is movable along the x-axis and the y-axis relative to the clamping device 2. The grinding device 3 includes a grinding wheel 31 and a guard 32, wherein the grinding wheel 31 located inside the guard 32 and is mounted to a driving shaft of a driving motor. A lid 321 is pivotably connected to a top of the guard 32 and located on one side of the guard 32. The lid 321 is opened by being lifted upward. The lid 321 is actuated by a first cylinder 322.

The storage device 4 is vertically mounted on the base 1 along a z-axis. Multiple grinding wheels 31 are detachably connected to the storage device 4 and are rotatable about the x-axis. The storage device 4 is connected to one side of the base 1 and includes a frame 41, a turntable 42, and a driving unit 43. The turntable 42 is hinged to a top of the frame 41 and carries the grinding wheels 31. The driving unit 43 is located between the frame 41 and the turntable 42, and electrically connected to the controller 6. The driving unit 43 drives the turntable 42 to rotate. Each grinding wheel 31 includes a spindle 311.

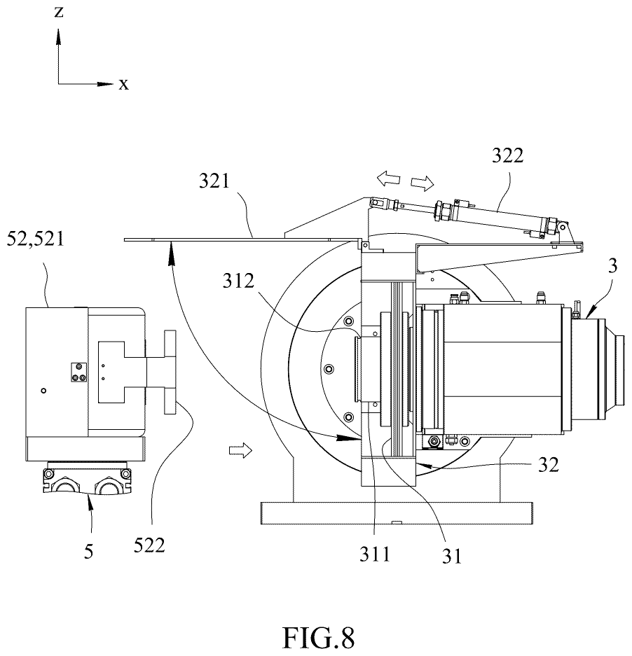

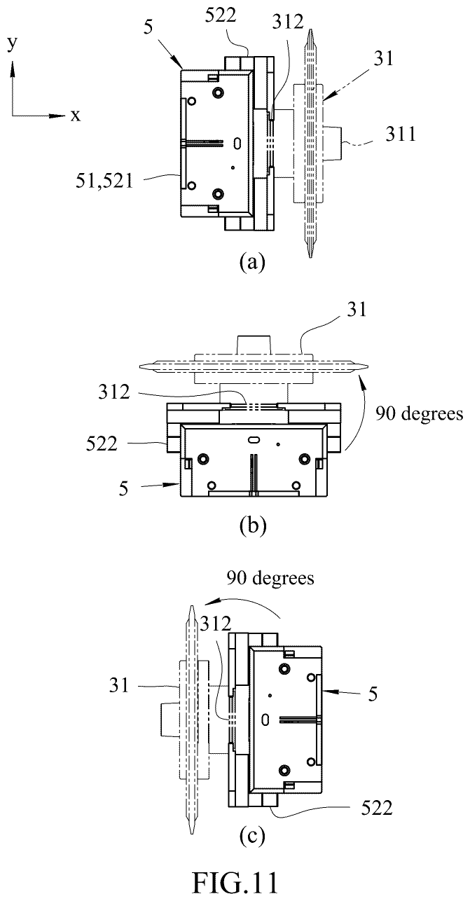

The gripping device 5 is mounted on the base 1 and positioned between the grinding device 3 and the storage device 4. The gripping device 5 is linearly movable along the x-axis relative to the base 1. The gripping device 5 includes a gripping unit 52 which is rotatable along the z-axis. Two claws 522 are connected to the gripping unit 52. The spindle 311 includes a locking groove 312 located relative to the two claws 522 of the gripping unit 52 as shown in FIGS. 8 and 11. The gripping device 5 is actuated by a second cylinder 51 so as to be move along the x-axis. The gripping unit 52 is rotated 180 degrees by a rotating cylinder 521, a stepper motor, or a servo motor.

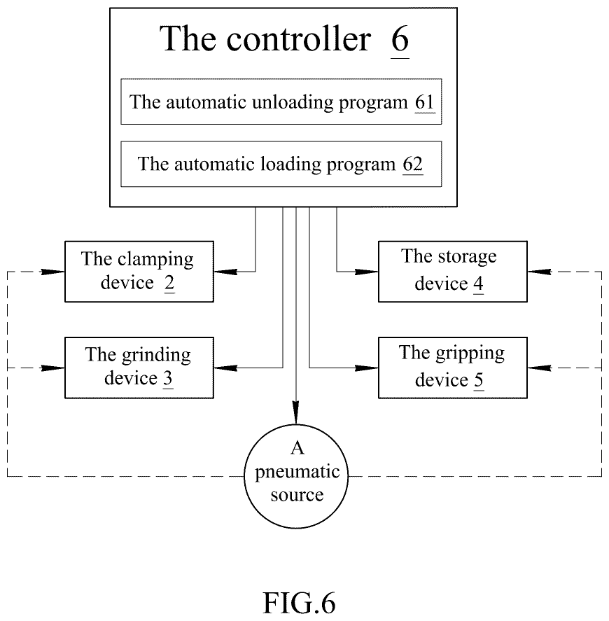

As shown in FIG. 6, the controller 6 is electrically connected to the clamping device 2, the grinding device 3, the storage device 4, and the gripping device 5. At the same time, it is also connected to a pneumatic source, which is used to control the pneumatic power supply to provide timely air pressure to the tailstock top pin of the clamping device 2, the first cylinder 322 of the grinding device 3, the second cylinder 51 and its rotating cylinder 521, and the two claws 522. However, the use of pneumatic power is not limited, and hydraulic power can also be applied to large grinding machines. The controller 6 includes an automatic unloading program 61 and an automatic loading program 62 stored therein. This actuates the gripping device 5 to grasp the grinding wheel 31 with its gripping unit 2 and shuttle back and forth, rotating between the grinding device 3 and the storage device 4, providing the functionality of automatic loading and unloading of the grinding wheel 31.

The present invention provides an improved solution for the grinding wheel changing mechanism. Upon completion of the grinding process for a workpiece 7, and when proceeding to the grinding process for the next workpiece 7, the controller 6 executes the automatic unloading program 61 and the automatic loading program 62. This allows for the automatic changing of the grinding wheel 31 based on the specific part of the workpiece 7 to be processed.

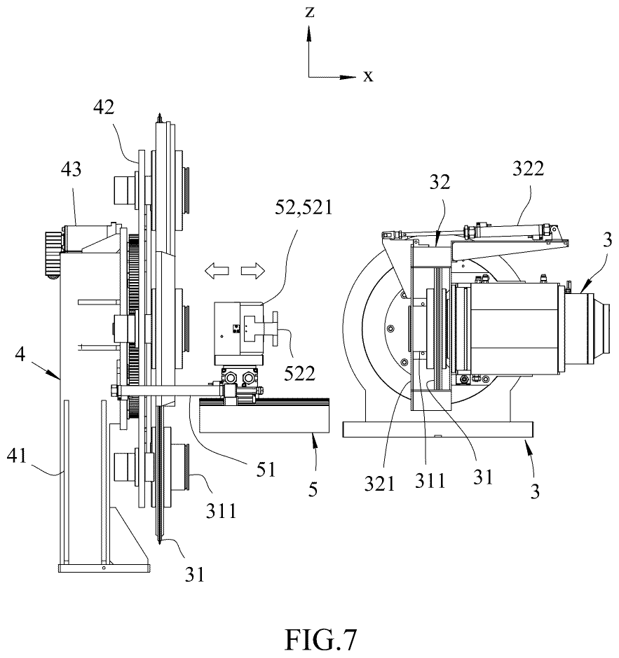

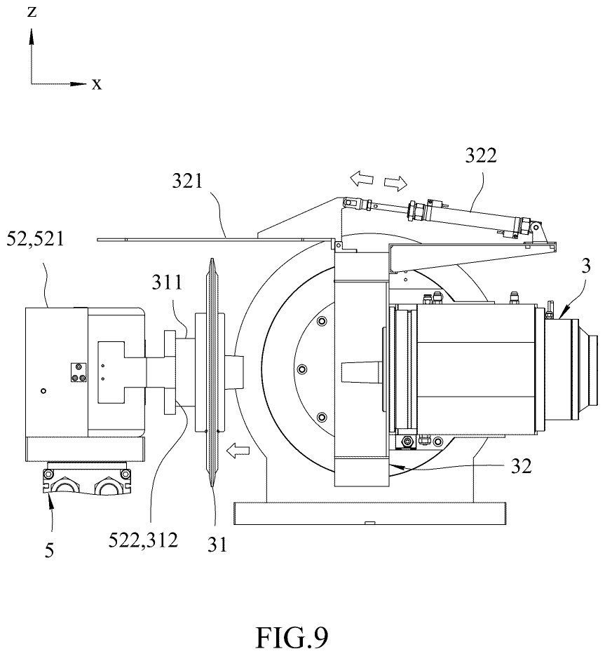

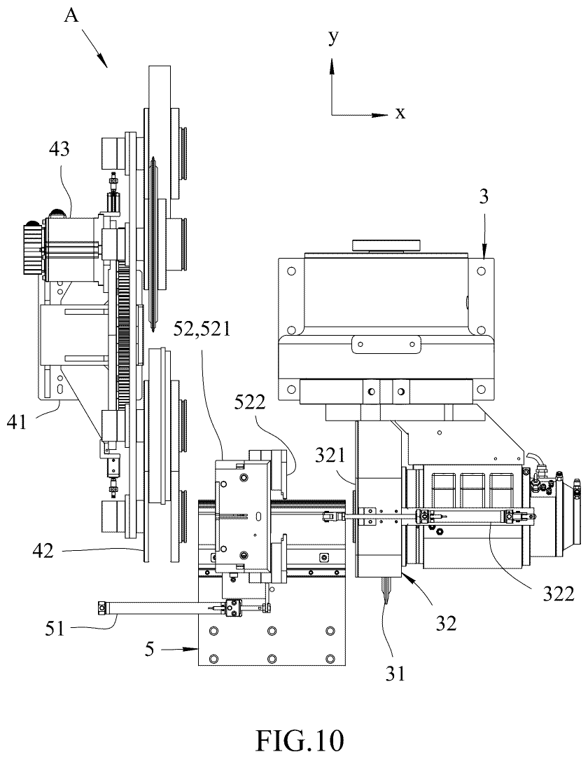

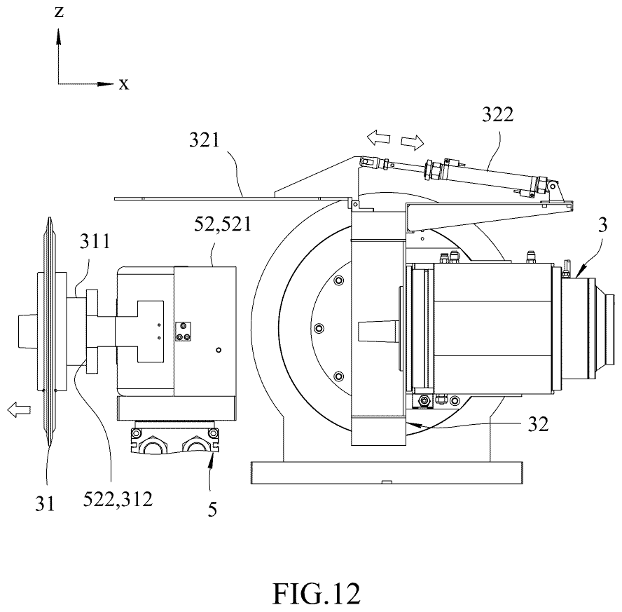

As shown in FIGS. 7 to 12, the automatic unloading program 61 is proceeded as follows:

moving the grinding device 3 away from the storage device 4 to a preset distance;

opening the lid 321 of the guard 32;

moving the gripping device 5 to approach the guard 32;

using the gripping unit 52 to grasp and unload the grinding wheel 31 to be unloaded in the guard 32 by engaging the two claws 522 with the locking groove 312 on the spindle 311 of the grinding wheel 31 to remove the grinding wheel 31 to be unloaded from the rotating shaft of the driving motor;

moving the gripping device 5 away from the guard 32 and using the gripping unit 52 to rotate 180 degrees to the grinding wheel 31 to be unloaded on the gripping device 5;

withdrawing the gripping device 5 and approaching the gripping device 5 toward the storage device 4;

inserting the grinding wheel 31 to be unloaded into the storage device 4, and

moving the gripping device 5 to return to an initial position to complete the automatic unloading program 61.

The automatic loading program 62 is proceeded as follows:

positioning one of the grinding wheels 31 to be loaded stored in the storage device 4 to a predetermined location;

moving the grinding device 3 away from the storage device 4 to a preset distance (if the grinding device 3 is located at the predetermined location, the step can be omitted);

opening the lid 321 of the guard 32 (if the lid 321 is already opened, the step can be omitted);

withdrawing the gripping device 5 to approach the storage device 4;

using the gripping unit 52 to grasp the grinding wheel 31 to be loaded from the storage device 4 by engaging the two claws 522 with the locking groove 312 of the spindle 311 of the grinding wheel 31 so as to move the grinding wheel to be loaded from the storage device 4;

moving the gripping device 5 and using the gripping unit 52 to rotate the grinding wheel 31 to be loaded 180 degrees;

moving the gripping device 5 to approach the guard 32;

inserting the grinding wheel 31 to be loaded into the guard 32 and connecting the grinding wheel 31 to be loaded to the driving shaft of the driving motor, and releasing the two claws 522;

withdrawing the gripping device 5 to an initial position, and

closing the lid 321 of the guard 32 to complete the automatic loading program 62.

While we have shown and described the embodiment in accordance with the present invention, it should be clear to those skilled in the art that further embodiments may be made without departing from the scope of the present invention.

What is claimed is:

1. A grinding wheel changing structure of grinding machines comprising:
a base (1);
a clamping device (2) mounted on the base (1) for clamping workpieces (7) of different lengths, the clamping device (2) being adjustable along an x-axis;
a grinding device (3) mounted on slide rails of the base (1) and being movable along the x-axis and a y-axis relative to the clamping device (2), the grinding device (3) includes a grinding wheel (31) and a guard (32), the grinding wheel (31) located inside the guard (32), a lid (321) located on a side of the guard (32) and actuated by a first cylinder (322);
a storage device (4) vertically mounted on the base (1) along a z-axis, multiple grinding wheels (31) detachably connected to the storage device (4) and being rotatable about the x-axis;
a gripping device (5) mounted on the base (1) and positioned between the grinding device (3) and the storage device (4), the gripping device (5) being linearly movable along the x-axis relative to the base (1), the gripping device (5) including a gripping unit (52) which is rotatable along the z-axis, and
a controller (6) controlling the gripping device (5) through the gripping unit (52) to grip the grinding wheel (31) and moving back and forth, and rotating between the grinding device (3) and the storage device (4) so as to provide automatic loading and unloading for the grinding wheel (31).

2. The grinding wheel changing structure of grinding machines as claimed in claim 1, wherein the controller (6) is electrically connected to the clamping device (2), the grinding device (3), the storage device (4), and the gripping device (5), the controller (6) includes an automatic unloading program (61) and an automatic loading program (62) stored therein.

3. The grinding wheel changing structure of grinding machines as claimed in claim 2, wherein the automatic unloading program (61) is proceeded as follows:
moving the grinding device (3) away from the storage device (4) to a preset distance;
opening the lid (321) of the guard (32);
moving the gripping device (5) to approach the guard (32);
using the gripping unit (52) to grasp and unload the grinding wheel (31) to be unloaded in the guard (32);
moving the gripping device (5) away from the guard (32) and using the gripping unit (52) to rotate the grinding wheel (31) to be unloaded on the griping device (5);
withdrawing the gripping device (5) and approaching the gripping device (5) toward the storage device (4);
inserting the grinding wheel (31) to be unloaded into the storage device (4), and
moving the gripping device (5) to return to an initial position to complete the automatic unloading program (61).

4. The grinding wheel changing structure of grinding machines as claimed in claim 2, wherein the automatic loading program (62) is proceeded as follows:
positioning one of the grinding wheels (31) to be loaded stored in the storage device (4) to a predetermined location;
moving the grinding device (3) away from the storage device (4) to a preset distance;
opening the lid (321) of the guard (32);
withdrawing the gripping device (5) to approach the storage device (4);
using the gripping unit (52) to grasp the grinding wheel (31) to be loaded from the storage device (4);
moving the gripping device (5) and using the gripping unit (52) to rotate the grinding wheel (31) to be loaded;
moving the gripping device (5) to approach the guard (32);
inserting the grinding wheel (31) to be loaded into the guard (32);
withdrawing the gripping device (5) to an initial position, and
closing the lid (321) of the guard (32) to complete the automatic loading program (62).

5. The grinding wheel changing structure of grinding machines as claimed in claim 2, wherein the lid (321) of the guard (32) is opened by being lifted upward, the lid (321 is pivotably connected to a top of the guard (32) and actuated by the first cylinder (322).

6. The grinding wheel changing structure of grinding machines as claimed in claim 2, wherein the gripping device (5) is actuated by a second cylinder (51), the gripping unit (52) is rotated by a rotating cylinder (521), a stepper motor, or a servo motor.

7. The grinding wheel changing structure of grinding machines as claimed in claim 2, wherein each grinding wheel (31) includes a spindle (311), the spindle (311) includes a locking groove (312) located relative to the gripping unit (52).

8. The grinding wheel changing structure of grinding machines as claimed in claim 7, wherein the storage device (4) is connected to one side of the base (1) and includes a frame (41), a turntable (42), and a driving unit (43), the turntable (42) is hinged to a top of the frame (41) and carries the grinding wheels (31), the driving unit (43) is located between the frame (41) and the turntable (42), and electrically connected to the controller (6), the driving unit (43) drives the turntable (42).

9. The grinding wheel changing structure of grinding machines as claimed in claim 1, wherein the gripping unit (52) is rotated 180 degrees.
